(19) United States
(12) Patent Application Publication
(10) Pub. No.: US 2006/0279713 A1
(43) Pub. Date: Dec. 14, 2006

(54) Illumination system for projectors

(75) Inventors: Kuo-Chuan Wang, Miao-Li Country (TW); Sze-Ke Wang, Miao-Li Country (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/443,018

(22) Filed: May 31, 2006

(30) Foreign Application Priority Data
Jun. 13, 2005 (TW) 094119423

(51) Int. Cl. G03B 3/00; G03B 21/14

(52) U.S. Cl. 353/101

(57) ABSTRACT

An illumination system for a projector includes a light source, a light valve and a movable lens set between the light source and the light valve. The movable lens set has lenses whose relative positions are alterable manually or automatically depending on different input source thereby to adjust the illumination area of the illumination system on the light valve so that the light source can converge light projection on the active area of the light valve without wasting the light source. And the optical structure of the illumination system does not have to be redesigned or changed for different resolution of light valve. Production cost of the illumination system of the projectors can be reduced.

### FIELD OF THE INVENTION

The present invention relates to a projector and particularly to an illumination system for projectors.

### BACKGROUND OF THE INVENTION

In the illumination system of conventional projectors, a light beam emitted from a light source passes through an optical structure which consists of a plurality of optical lenses to be directed to a light valve. Different types of projectors have different resolutions, such as Super Video Graphics Array (SVGA ) (800*600) Extended Graphics Array (XGA) (1024*768) or Super Extra Graphics Array (SXGA⁺) (1400*1050). The light valve of different resolution usually has a different physical dimension. Once the resolution of the projector changes, a size of the light valve also need to be changed. Hence in the conventional projector, when the specification of the resolution changes, the optical structure located between the light source and the light valve has to be redesigned. And parameters of the optical lenses and distance between the lenses have to be re-established. As the projectors of different resolutions cannot share the same optical structure, production cost is higher.

Refer to FIG. 1 for a light valve based on a digital micro-mirror device (DMD) chip set. It indicates the active area of the DMD chip set of different resolutions and the illumination area of the light source of the illumination system. For the XGA resolution (1024*768), a DMD chip set D1 of 0.7 inch (diagonal length) is usually used. For the SVGA resolution (800*600), a DMD chip set D2 of 0.55 inch is usually used. The following table shows the light source efficiency (namely utilization of light) of DMD chip sets of different specifications under the same illumination system and optical structure. XGA IL indicates the illumination area of XGA illumination system. XGA indicates the active area of the XGA chip set. SVGA IL indicates the illumination area of SVGA illumination system. SVGA indicates the active area of the SVGA chip set.

| | XGA IL | XGA | SVGA IL | SVGA |
|---|---|---|---|---|
| XGA IL | 100% | 82.64% | 61.04% | 50.44% |
| XGA | 121.00% | 100% | 73.85% | 61.04% |
| SVGA IL | 164.00% | 135.00% | 100% | 82.64% |
| SVGA | 198.00% | 164.00% | 121.00% | 100% |

As shown in FIG. 1 and the table above, in the condition of the XGA illumination system having 100% of light source efficiency without altering the optical structure, if the DMD chip set of the XGA specification is changed to the DMD chip set of the SVGA specification, the dimension of the DMD chip set under the SVGA specification is smaller, a portion of the light beam does not project to the active area of the DMD chip set of the SVGA specification. Hence a portion of the light beam is wasted. The light efficiency of the illumination area becomes 73.85% of the original light efficiency. The light efficiency in the active area even is reduced to 61.04% of the original one. A great amount of light beam is lost. As the illumination system of a conventional optical structure can use only the light valve of a single resolution, the SVGA illumination system cannot support the XGA light valve. If the SVGA light valve is directly used in the XGA illumination system, the light beam loss is too great and the light efficiency decreases.

On the other hand, the screen ratio used by the conventional projector mostly is 4:3. If the image specification (such as the resolution or the screen ratio) of a signal source input to the light valve is different from the light valve, the generated illumination area cannot match an image specification of the signal source. As a result, the illumination system of the ration 4:3 cannot fully take the benefit of the light beam efficiency.

### SUMMARY OF THE INVENTION

Therefore it is an object of the present invention to provide an illumination system for projectors that can adjust the illumination area of the illumination system to a light valve without redesigning the optical structure of the illumination system.

According to an embodiment of the invention, a zoom illumination system is provided that includes a light source, a light valve and a movable lens set between the light source and the light valve. The relative position of the movable lens set in the illumination system is altered to adjust the illumination area of the illumination system to the light valve.

Another object of the invention is to provide a zoom illumination system that can change manually or automatically the illumination area to the light valve according to the signal source of different image specifications.

The invention employs a movable lens between the light source and the light valve. The relative position of the lens is changed according to the signal source of different image specifications projecting to the light valve, thereby the illumination area of the illumination system to the light valve is adjusted to enable the light beam of the light source to be converged and projected to the light valve to prevent waste of the light beams.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a plane view of a conventional light valve showing the active area of the light valve of different specifications and illumination areas projected by the light source of the illumination system.

FIG. 2 is a schematic view of an embodiment of an illumination system of the present invention.

FIG. 3A is a schematic view of projected light beams of a zoom illumination system adopted a XGA (1024*768) light valve.

FIG. 3B is a schematic view of projected light beams of a zoom illumination system adopted a SVGA (800*600) light valve.

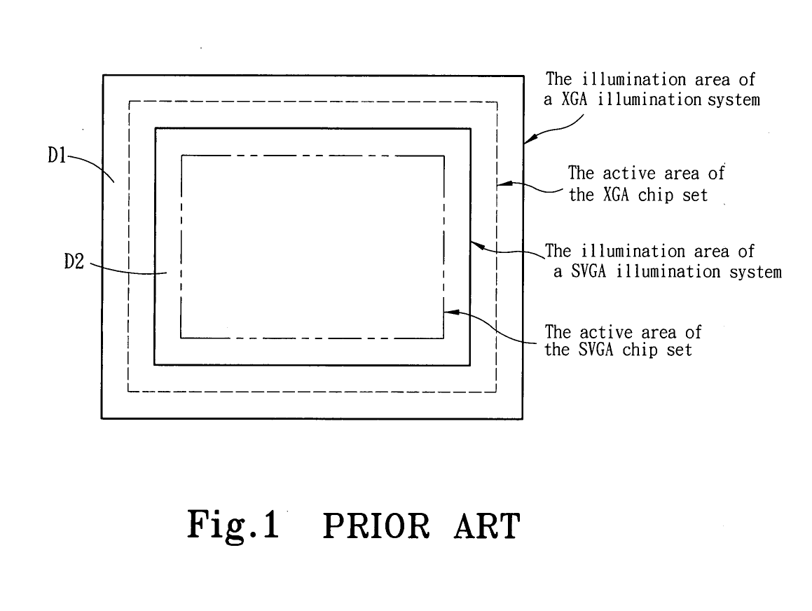

### DETAILED DESCRIPTION OF THE PREFERRED EMBODIMENTS

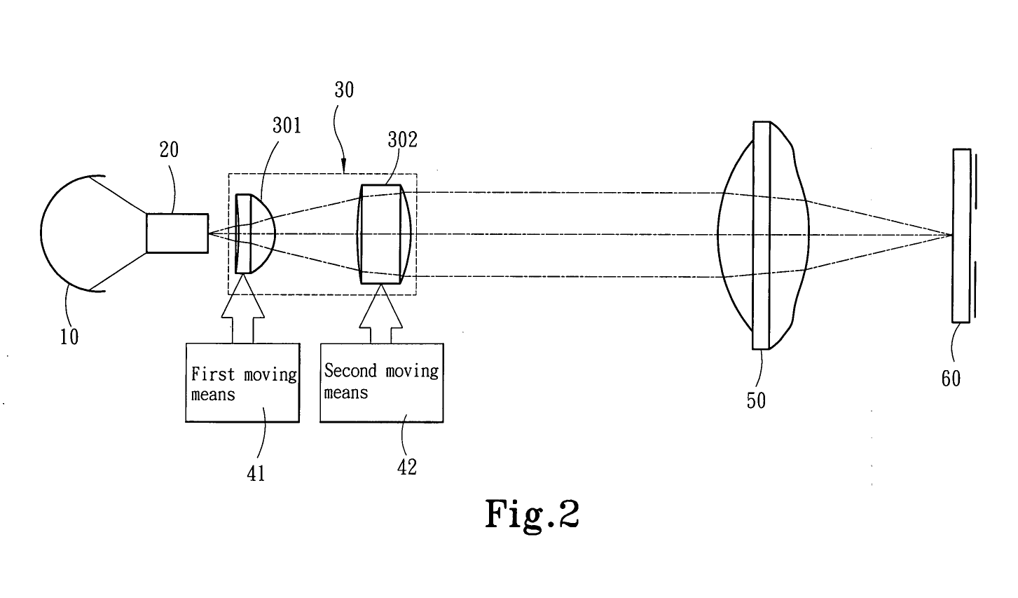

Please refer to FIG. 2, the illumination system according to the invention includes a light source 10, a light valve 60 and a zoom unit located between the light source 10 and the light valve 60. The zoom unit includes a movable lens set 30, a first moving means 41, a second moving means 42, and a relay lens 50. There is a light tunnel 20 located between the light source 10 and the zoom unit to uniform the light beam originated from the light source 10. The light tunnel 20 includes an integration rod.

The light source 10 generates light required in the illumination system. The light source 10 emits a light beam which passes through the light tunnel 20 to be uniformed. Then through focusing adjustment of the movable lens set 30 and the relay lens 50, the light beam projects to the light valve 60. The relay lens 50 is an aspherical lens, curved reflective mirror or a spherical lens. The relative position of the relay lens 50 and the light valve 60 is constant.

According to an embodiment of the invention, the movable lens set 30 is located between the light source 10 and the relay lens 50. The movable lens set 30 includes at least a first movable lens 301 and a second movable lens 302. The first movable lens 301 and the second movable lens 302 are selected from a positive power spherical lens, an aspherical lens or a combination thereof. The first moving means 41 aims changes the position of the first movable lens 301. The second moving means 42 aims changes the position of the second movable lens 302. The first moving means 301 and the second moving means 302 are operated electrically or manually.

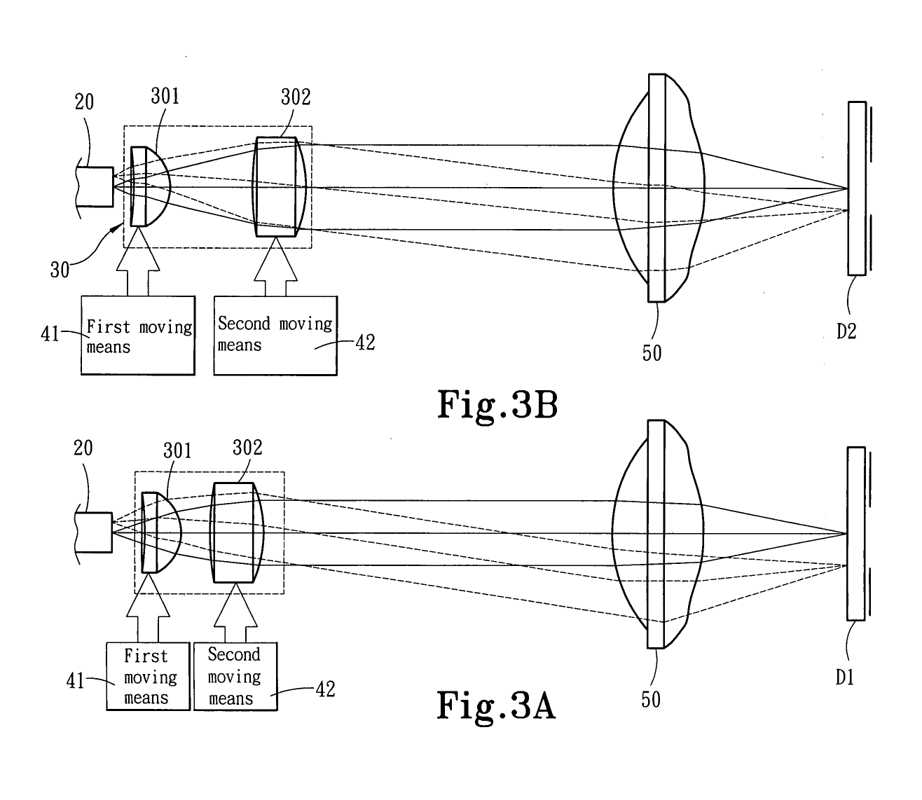

Refer to FIG. 3A for an optical structure that adopts a DMD chip set D1 of XGA (1024*768) resolution as the light valve 60. Through the first moving means 41 and the second moving means 42 to change the relative position of the first movable lens 301 and the second movable lens 302, the light beam emitted from the light source 10 projects to the active area of the DMD chip set D1. Referring to FIG. 3B, under the same optical structure, but changing the optical valve 60 to a smaller SVGA (800*600) DMD chip set D2, by means of the first moving means 41 and the second moving means 42 to alter the relative position of the first movable lens 301 and the second movable lens 302, the illumination area projected to the SVGA DMD chip set D2 can be adjusted to the active area thereby to reduce the waste of the light beams. Hence light beam utilization efficiency increases.

Based of the embodiments set forth above, it is clear that the zoom illumination system of the invention can be adopted to the light valve of different resolutions without redesigning or changing the optical structure. The light efficiency can be maintained without dropping. The cost is lower. When the light beam of the signal source of different image specifications is projected to the light valve, the illumination area of the illumination system to the light valve may be adjusted by changing the relative position of the lenses, and the light beam of the light source can be converged and projected to the light valve to prevent waste of the light beams.

What is claimed is:

1. An illumination system for projectors, comprising:
a light source for providing a light beam;
a light valve; and
a zoom unit located between the light source and the light valve to focus and adjust the light beam to project the light beam to an active area of the light valve, the zoom unit comprising a movable lens set and a moving means which alters a position of the movable lens set in the illumination system to adjust an illumination area on the light valve.

2. The illumination system for projectors of claim 1, wherein the movable lens set comprises at least a first movable lens and a second movable lens, the moving means comprises a first moving means to alter a position of the first movable lens and a second moving means to alter a position of the second movable lens.

3. The illumination system for projectors of claim 2, wherein the first movable lens and the second movable lens are selected from a positive power spherical lens, an aspherical lens and a combination of the spherical lens and the aspherical lens.

4. The illumination system for projectors of claim 1, wherein the moving means is operated electrically or manually.

5. The illumination system for projectors of claim 1, wherein the zoom unit includes a relay lens.

6. The illumination system for projectors of claim 5, wherein the relay lens is a spherical lens.

7. The illumination system for projectors of claim 5, wherein the relay lens is a curved reflective mirror.

8. The illumination system for projectors of claim 1 further comprising a light tunnel between the light source and the zoom unit.

9. The illumination system for projectors of claim 8, wherein the light tunnel is an integration rod.
